(19) United States
(12) Patent Application Publication
(10) Pub. No.: US 2006/0254529 A1
(43) Pub. Date: Nov. 16, 2006

(54) Flooring components and unitary permanent floor constructed therefrom

(76) Inventor: Danny L. Padgett, Tipp City, OH (US)

Correspondence Address: WILLIAM WEIGL, 1805 Conwood Dr., Troy, OH, 45373, US

(21) Appl. No.: 11/125,944

(22) Filed: May 11, 2005

(51) Int. Cl. A01K 1/015

(52) U.S. Cl. 119/526

(57) ABSTRACT

A plurality of rectangular mat sections that are light enough in weight so as to be handled manually are assembled within an animal stall and permanently adhesively secured to one another into an integral, unitary mat assembly. The mat sections have overlapping surfaces for adhesive reception and are interconnected in a manner somewhat resembling the construction of acoustic ceiling tile. Upon completion of assembly, the mat sections result in a heavy one-piece floor mat that avoids buckling or shifting, is comfortable for the animal and is easy to clean and maintain.

This invention was originally designed to provide a unitary floor mat for use in a large horse stall, namely, a mat that was liquid impervious, permanent, cushioned and fixed in position. Its intent was to have a mat that would avoid buckling or moving about in the stall, not only for the animal's safety and comfort but also for ease of stall cleaning and maintenance. In progression of the design, its much broader applicability for other types of permanent flooring became apparent. The invention's overall goal is to provide a flooring assembly made of individual components or sections that, when assembled, provide a unitary, one-piece floor.

### BACKGROUND OF THE INVENTION

For convenience, description of the invention will first focus on its original design intent. A typical horse stall has either a dirt or concrete floor with a bedding of straw, wood shavings or pelletized sawdust, the latter of which is described in my U.S. Pat. No. 6,474,267 granted Nov. 5, 2002. Some horsemen have placed edge-abutting but unconnected rubber mat sections of dimensions such as 4′×6′, 4′×8′ and 4′×10′ on a dirt floor in an attempt to contain urine. Straw or another bedding was placed atop the rubber floor, but urine was only partially absorbed by the bedding and leaked through the open joints to contaminate the dirt below, creating a health as well as an odor problem. Those loosely laid mats are easily shifted and buckled in response to a horse walking or “pawing”. The bedding was free to sift through the cracks and under the mats, making cleaning and stall maintenance with the usual manure fork somewhat difficult. Others have rolled out large liquid-impervious rubber mats like carpeting, in stalls that are typically 12′×12′ or 12′×10′ in size. To be effective, the full size mats have to be of sufficient thickness to be “paw-proof” from disarrangement by the horse. If the full size mat is thin enough to lay flat, but light enough to handle as a single piece, it is also most likely to buckle readily. If a full size mat is thick enough to avoid the buckling, it can be very heavy, nearly impossible for a single individual to lay manually and can also be costly as well. The need remained for a permanent resilient cushioned type horse stall floor that could be easily installed by a single individual if necessary, easy to maintain and clean, of sufficient thickness to avoid the tendency to buckle and economically within the range of most large animal keepers.

### SUMMARY OF THE INVENTION

A plurality of individual rectangular, preferably square mat sections that are light enough in weight so as to be handled manually are assembled within an animal stall and permanently adhesively secured to one another into an integral, unitary floor assembly. The mat sections have overlapping edge surfaces for adhesive reception and are interconnected in a manner somewhat resembling the construction of an acoustic ceiling from individual tiles. Upon completion of assembly, the mat sections result in a heavy one-piece floor mat that avoids buckling or shifting, is comfortable for the animal, is preferably liquid-impervious and is easy to clean and maintain. When used in conjunction with an absorptive bedding material, the mat assembly and bedding tend to improve and enhance the overall health and safety of a stalled animal.

### DESCRIPTION OF THE DRAWINGS

FIG. 1 is an enlarged isometric view of one of the mat sections of the invention.

FIG. 2 is a horizontal enlarged view of a mat section illustrating an imaginary plane referred to in the description and claims in order to define the shape and construction of each mat section.

FIG. 3 is an isometric view of a 12′×12′ stall floor assembly made up of nine 4′×4′ mat sections for a typical stall, prior to edge trimming and securing to walls of the stall.

FIG. 4 is a plan view similar to the showing in FIG. 3 but illustrating an alternative arrangement of mat sections.

FIG. 5 is a fragmentary view of two adjacent mat section edges being registered for adhesive bonding into a unitary, liquid-impervious assembly.

FIG. 6 is an enlarged vertical cross-sectional view showing cove molding for securing one edge of a mat assembly to a wall of a stall.

FIG. 7 is an enlarged vertical cross-sectional view showing an edge of a stall mat assembly at a doorway into the stall.

FIG. 8 is a plan view of one alternative form of registering and aligning elements for use in creating a floor assembly.

FIGS. 9 and 10 illustrate still another alternative form of mat section, the latter figure being a cross-sectional view taken along lines 10-10 of FIG. 9.

FIG. 11 is an enlarged cross-sectional fragmentary view of a pair of adjoining mat sections of the FIG. 9 version in an interlocked condition.

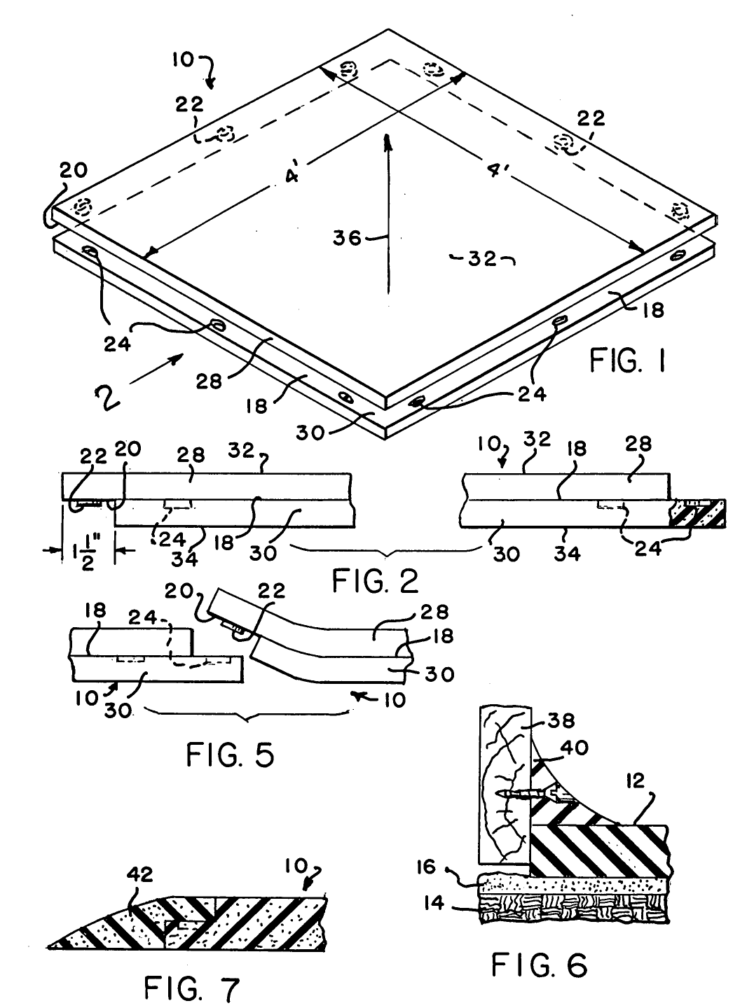

### DESCRIPTION OF THE PREFERRED EMBODIMENT

A mat section 10 illustrated in FIG. 1 is assembled along with other similar mat sections into a stall floor assembly 12 shown in FIG. 3. Since stalls for horses are typically 10′×12′ or 12′×12′ in size, I prefer to make the mat sections square and 4′ by 4′ in dimension. The size is not as critical as the weight, however, since installation by a single individual is a desired goal. FIG. 3 shows the assembly as originally laid in a stall as it would appear before any knife-trimming of the edges has taken place.

The mat section 10 is preferably made of crumb rubber salvaged from automobile tires bonded together at the time of being compression-molded as discussed in U.S. Pat. No. 5,989,695 granted on Nov. 23, 1999 to Fuller et al. The '695 patent disclosure is incorporated herein as an example of one material from which the mat section 10 can be made. For horse stall use, the mat section 10 is preferably between ¾ths and 1½ inches in thickness. If desired, the top surface may be coated with a new high-tech coating designated Armadillo Coat™ and made by Lauren Composite Technologies of New Philadelphia, Ohio. The coating adds wear resistance to the top surface and can be produced in any of numerous colors. When used in an animal stall, assembly 12 is preferably made impervious to liquid such as urine or, by using the appropriate ratio of adhesive to rubber crumbs. Or, if desired, it can be made slightly porous for primary use in a horse washing stall that has a concrete floor and drain beneath the floor assembly. The existence or extent of porosity is entirely dependent on the intended use of the assembly and can be adjusted as desired.

It can be seen from FIG. 1 that the mat section 10 somewhat resembles an acoustic ceiling tile. There are substantial differences, however, because of the manner in which the construction of the floor assembly 12 takes place. At ¾ inches in thickness, each 4′×4′ mat section weighs on the order of sixty pounds. This can be readily handled by one installer, but obviously, if thicker and thus heavier, may be better handled by a pair of installers.

As noted earlier, use of this particular material for this purpose is not new. The aforementioned Fuller '695 disclosure places edge-butting sections against one another. Because the sections would be unsecured, they might be easily disturbed by a “pawing” horse, could become subject to urine leakage at the open edges, and could cause potential problems of a manure fork catching the edges during stall cleaning. With cracks where the mats join, one can be fairly sure that debris and manure will tend to sift between the cracks and cause buckling or lifting at the adjacent mat edges. This could lead to health problems for the horse. Once debris begins to collect, the buckled sections would exacerbate cleaning-associated problems and increase stall maintenance time. Thus, Fuller fell substantially short of providing a satisfactory stall floor, particularly since it is not a permanent unitary structure upon completion of the installation.

Prior to installing a stall mat 12, the stall should be prepared by first making a complete cleaning of the earth 14 (FIG. 6), creating a base surface 16 of finely crushed limestone or crumb rubber, and placing mat sections 10 in their final positions as shown in FIG. 3. Depending on the stall size, (oftentimes they are not perfectly square or rectangular), knife trimming may be necessary. For example, in order to make the assembly 12 perfectly solid throughout, ledges formed by the outermost lower adhesive-receiving surfaces 18 of the assembly may need to be removed. Similarly, ledges formed by upper adhesive-receiving surfaces 20 around two opposing side edges of the assembly 12 might also be removed.

Construction of the stall mat 12 into a one-piece assembly proceeds as follows. With all mat sections 10 in place and with all registering elements depicted in various views as male protrusions 22 and female cavities 24 respectively, adhesive bonding is able to commence. The bonding adhesive is a two-part component designated Lap & Seal and produced by Lauren Composite Technologies of New Philadelphia, Ohio. The adhesive may be applied from a pair of tubes that mix the adhesive components at an applying tip of a two-tube mixing gun marketed by T.A.H. Manufacturing of Kentucky. The mixing occurs just as the adhesive is deposited on the lower surface 18 while the underside surface 20 of the upper ledge is held up and away from the surface 18. The adhesive is one that can allow for timing of the mixed adhesive to completely set within a predetermined period of from between 10 and 30 minutes, depending of the formulation of the two parts of the adhesive. The installer is thus able to select where to begin and end the adhesive application. With experience, an installer will find how to avoid any dislocation of mat sections 10 during adhesive application, oftentimes based on the design and ease of interlocking of the registering elements 22 and 24.

Because of the unusual shape of the mat section 10 and the difficulty of describing its appearance in words, I have decided to refer in FIG. 2 to an imaginary plane 26 intersecting the mat section horizontally, preferably midway between an upper portion 28 and a lower portion 30. Obviously, these portions are integral, the imaginary plane being referred to solely for the purpose of defining the shape of the mat section. In this same view, I define the mat section as having a top surface 32 and a bottom surface 34. As viewed in FIG. 1, it can be imagined that the mat section 10 is one solid piece having length, width and height, but the upper section 28 has been slid or moved in the direction of a line 36 between two opposing corners so as to be offset in order to create the adhesive-receiving surfaces 18 and 20. An example might be to imagine the top one of two square slices of bread being shifted in its plane in the direction of the arrow on the diagonal line 36 while preparing a sandwich. This description is solely for purposes of considering the intent and meaning of the appended claim language.

In FIGS. 1 and 2, I show a plurality of the male and female registering elements 22 and 24 respectively. They may be as few in number as shown in FIG. 1 where twelve (six of each) are located on each mat section 10. Or, they can appear as a single notch at each edge as shown in FIG. 8. Their design can be of any shape, and in fact can even be alignment marks that assist in positioning the mat sections without interlocking. If the mat sections are laid out in the pattern of FIG. 3, the registering elements are all utilized. However, if laid out in the staggered design of FIG. 4 to have larger sections of the mat sections adhering to each other, certain of the male elements 22 could be sheared off. It can be noted that the notched registering design of FIG. 8 does not lend itself to the mat section layout of FIG. 4.

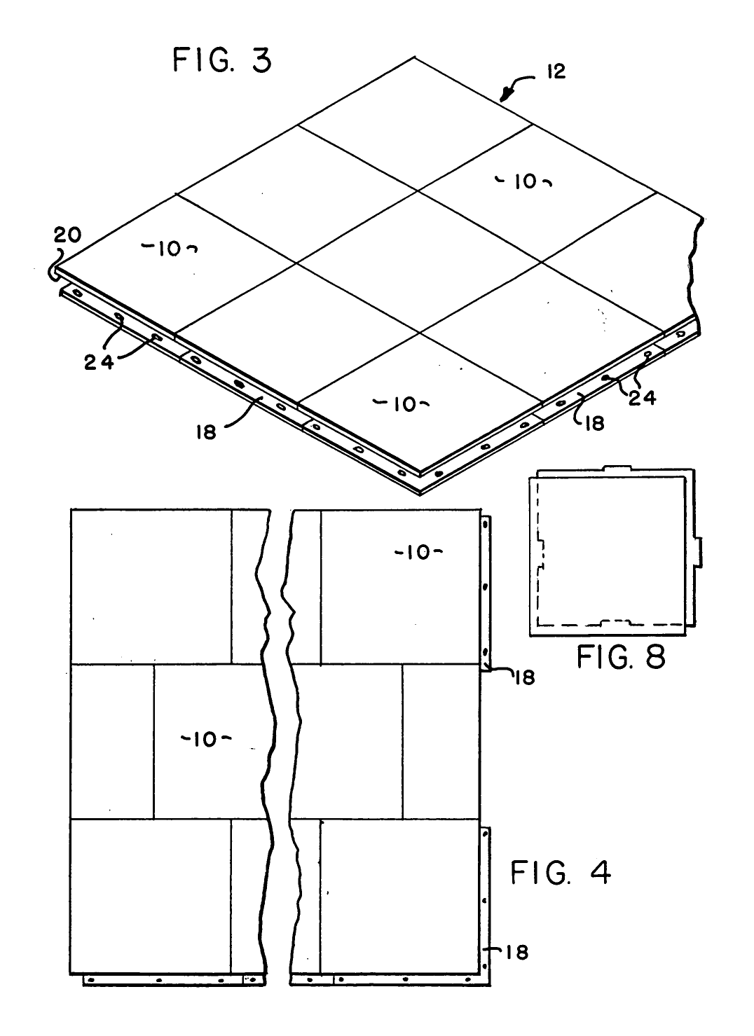

FIGS. 6 and 7 illustrate treatment of the mat assembly 12 where it attaches to a wall 38 of the stall. A coved baseboard 40 that is preferably an extruded length of an appropriate material is first glued to the mat assembly 12 and wall 38 and then screwed to the wall as shown. In effect, the mat assembly 12 then becomes a wall-to-wall covering over the entire stall, and is retained at its edges to the opposing walls of the stall. At the entrance or doorway into the stall, a threshold 42 can be glued to a portion of the mat assembly and extend to or into the entrance. Preferably, a wood cross member such as a 4″×4″ embedded in the earth (not shown) can be used below the threshold for screwing it thereto for stability.

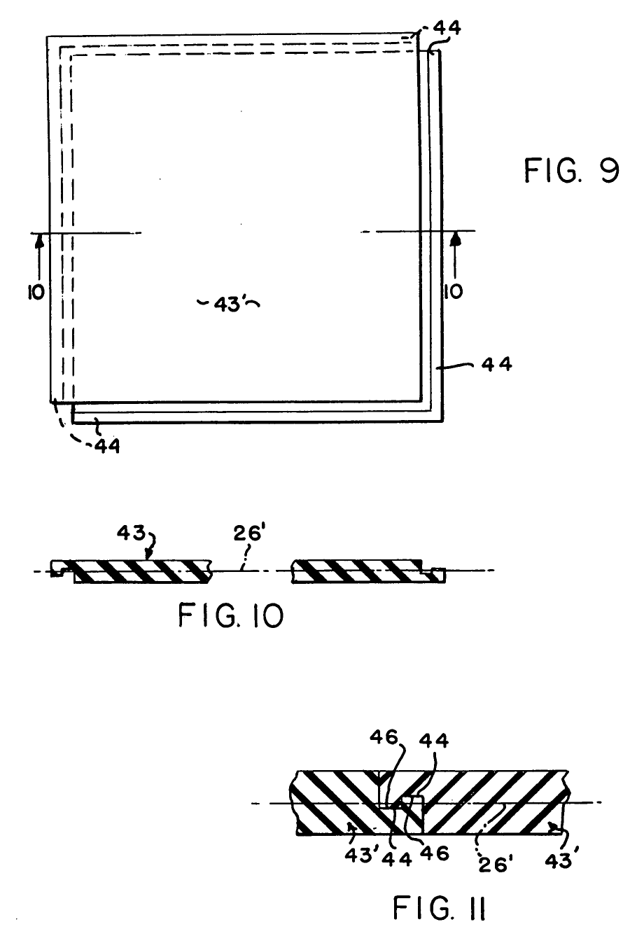

In FIG. 9, I illustrate the top plan view of yet another form of the mat section 43′ and its registering system. Two adjacent outer edges 44 of both the top and bottom surfaces protrude, when interlocked, into receiving grooves 46 of an adjoining mat section, as shown in FIG. 11. It will be noted that in this version, the outer edges 44 and the bottoms of the grooves 46 are offset a small equal distance from an imaginary plane 26′.

The various registering elements serve not only to align the mat sections when originally laying out the floor, but also to maintain that alignment when walking over the floor before gluing takes place. Since it is often necessary to walk on the floor while assembling it and also during the process of gluing it, it is important to have the registering elements maintain alignment prior to the adhesive setting completely.

Since originally conceiving the mat assembly for horse stalls, its usefulness for other purposes has become apparent. Exercise rooms, gymnasiums, kitchens, libraries, garage and basement floors, decks and patios, showers and locker rooms are all potential applications of the concepts disclosed herein. Obviously, still other floor applications remain to be explored. The options for floor surface patterns and types of surface coating, e.g., cobblestone, soldier brick pattern, etc. are seemingly endless. In such situations, for aesthetic reasons, the assembly can be laid out with the joints extending diagonally to the walls. And, depending on the selection of the type of registering elements used, various other mat patterns are possible without departing from the spirit of my invention.

Having described my invention, I claim:

1. A flat horizontal floor assembly permanently constructed from individual sections into a unitary cushioned floor, said individual sections each being of a weight and size as to be capable of being manually lifted and handled during construction and said assembly being relatively manually immovable once constructed, said floor assembly comprising:
a) a plurality of said individual sections, each of which is to be joined with other such sections into said assembly by a floor installer, each of said sections including a flat rectangular upper portion of a predetermined thickness and a flat rectangular lower portion of a predetermined thickness integrally joined along an imaginary plane extending approximately midway between and parallel to top and bottom surfaces of said section;
b) all of said sections of said floor assembly being rectangular;
c) the upper and lower portions of each section being offset along a line extending between a pair of opposing corners for a nominal distance whereby to provide sufficient horizontal adhesive-receiving surfaces at the underside of a pair of adjoining edges of said upper portion and at the upper side of a pair of adjoining edges of said lower portion, all of said adhesive-receiving surfaces lying within said imaginary plane; and
d) a permanent adhesive applied between facing adhesive-receiving surfaces to bond said sections into said unitary cushioned floor.

2. A floor assembly according to claim 1 wherein each section is molded from crumbs produced from salvaged automotive tires.

3. A floor assembly according to claim 1 wherein a plurality of mating registering elements are provided on the adhesive-receiving surfaces of all sections in like locations for physically aligning individual sections with one another during assembly.

4. A floor assembly according to claim 4 wherein said registering elements comprise male elements on the undersides of the upper portions and female elements on the upper sides of said lower portions.

5. A floor assembly according to claim 1 wherein said rectangular shape is square.

6. A floor assembly according to claim 1 wherein said imaginary plane is midway between said top and bottom surfaces and said predetermined thicknesses of said upper and lower portions are identical.

7. A floor assembly according to claim 1 wherein said individual sections are between ¾ and 1½ inches in thickness.

8. A mat section adapted to be permanently adhesively secured to other like mat sections of a floor assembly thereof for creating a cushioned flooring mat, comprising:
a) a relatively flat rectangular body having an upper portion and a lower portion joined along an imaginary plane extending approximately midway between and parallel to top and bottom surfaces of said body; and
b) the upper and lower portions of each mat section being offset along a line extending between a pair of opposing corners for a nominal distance whereby to provide sufficient horizontal adhesive-receiving surfaces at the underside of a pair of adjoining edges of said upper portion and at the upper side of a pair of adjoining edges of said lower portion, all of said adhesive-receiving surfaces lying within said imaginary plane.

9. A mat section according to claim 8 wherein said rectangular shape is square.

10. A mat section according to claim 8 wherein said imaginary plane is midway between said top and bottom surfaces.

11. A mat section according to claim 8 wherein said mat section is between ¾ and 1½ inches in thickness.

12. A mat section according to claim 10 wherein a plurality of registering elements are provided in like locations on each mat body for alignment with registering elements on other like mat sections during assembly into a unitary floor.

13. A mat section according to claim 12 wherein said registering elements are provided on said adhesive-receiving surfaces.

14. A mat section according to claim 12 wherein a plurality of said mat sections are joined into an integral floor assembly for use in an animal stall.
